(19) United States
(12) Patent Application Publication
(10) Pub. No.: US 2019/0344483 A1
(43) Pub. Date: Nov. 14, 2019

(54) RESIN-SEALED COMPONENT AND METHOD FOR PRODUCING SAME

(71) Applicant: DENSO CORPORATION, Kariya-city (JP)

(72) Inventors: Hiroyuki OKUHIRA, Kariya-city (JP); Masakazu ATSUMI, Kariya-city (JP)

(21) Appl. No.: 16/524,629

(22) Filed: Jul. 29, 2019

Related U.S. Application Data
(63) Continuation of application No. PCT/JP2018/000922, filed on Jan. 16, 2018.

(30) Foreign Application Priority Data
Feb. 10, 2017 (JP) 2017-023260

(51) Int. Cl. B29C 39/12; C08L 75/04; C08L 63/00; C08G 18/76; C08G 59/42; B29C 39/10

(52) U.S. Cl. CPC B29C 39/123; C08L 75/04; C08L 63/00; C08L 2203/206; C08G 59/42; B29C 39/10; C08G 18/7642

(57) ABSTRACT

A resin-sealed component includes a part to be sealed, a first sealing member covering at least a part of the part to be sealed, and a second sealing member sealing a surface of the first sealing member. The first sealing member and the second sealing member are made of thermosetting resins. The second sealing member is made of the thermosetting resin having a gelation time longer than that of the first sealing member.

### CROSS REFERENCES TO RELATED APPLICATIONS

The present application is a continuation application of international Patent Application No. PCT/JP2018/000922 filed on Jan. 16, 2018, which designated the United States and claims the benefit of priority from Japanese Patent Application No. 2017-023260 filed on Feb. 10, 2017. The entire disclosures of all of the above applications are incorporated herein by reference.

### TECHNICAL FIELD

The present disclosure relates to a resin-sealed component and a method for producing the same.

### BACKGROUND

There is a resin-sealed component in which a part to be sealed such as a substrate mounted with electronic components or the like is sealed with a first sealing member and a second sealing member.

### SUMMARY

It is an object of the present disclosure to provide a new and useful resin-sealed component and a new and useful method for producing the same.

In a first aspect of the present disclosure, a resin-sealed component comprises: a part to be sealed; a first sealing member covering at least a part of the part to be sealed; and a second sealing member sealing a surface of the first sealing member. The first sealing member and the second sealing member are made of thermosetting resins. The second sealing member is made of the thermosetting resin having a gelation time longer than that of the first sealing member. The second sealing member may be made of the thermosetting resin having the gelation time longer than that of the first sealing member by 20 minutes or more.

In an second aspect of the present disclosure, a method for producing a resin-sealed component including: a part to be sealed; a first sealing member covering at least a part of the part to be sealed and made of a cured product of a first thermosetting resin composition; and a second sealing member covering a surface of the first sealing member and made of a cured product of a second thermosetting resin composition is provided. The method comprises: introducing the first thermosetting resin composition to cover, with the first thermosetting resin composition, at least a part of the part to be sealed; introducing the second thermosetting resin composition having a gelation time longer than that of the first thermosetting resin composition to cover the first thermosetting resin composition with the second thermosetting resin composition; and heating the first thermosetting resin composition and the second thermosetting resin composition to obtain the resin-sealed component. The second thermosetting resin composition may have the gelation time longer than that of the first thermosetting resin composition by 20 minutes or more. According to the above resin-sealed component and the method for producing the same, excellent contactness between the first sealing member and the second sealing member may be realized.

### BRIEF DESCRIPTION OF DRAWINGS

The above and other objects, features, and advantages of the present disclosure will become more apparent from the following detailed description with reference to the accompanying drawings.

FIG. 1 is a cross-sectional view of a resin-sealed component according to an embodiment.

FIG. 2 is a partial cross-sectional view of an interface between a first sealing member and a second sealing member of the resin-sealed component according to the embodiment.

FIG. 3 shows process of a method for producing the resin-sealed component according to the embodiment.

FIG. 4 is a partial cross-sectional view of an interface between a first sealing member and a second sealing member of a resin-sealed component according to a comparative example.

FIG. 5 is a drawing illustrating a molecular structure of a polyurethane resin having a structural unit derived from a polyol and a structural unit derived from tetramethylxylylene diisocyanate according to an experimental example.

### DETAILED DESCRIPTION

There is a resin-sealed component in which a part to be sealed such as a substrate mounted with electronic components or the like is sealed with a first sealing member made of a thermosetting resin and a second sealing member made of a thermoplastic resin. Such a resin-sealed component may be produced for example, as follows.

First, a part to be sealed is covered with a thermosetting resin and the thermosetting resin is cured, and thereby a first sealing member is formed. Thereafter, a surface of the cured first sealing member is covered with a thermoplastic resin and the thermoplastic resin is cured, and thereby a second sealing member is formed.

In this resin-sealed component, improvement in contactness between the first sealing member made of the thermosetting resin and the second sealing member made of the thermoplastic resin is desired. In this regard, there is a proposed technique of covering, with thermosetting resin materials having different curing temperatures, a part to be sealed.

In the proposed technique, a first thermosetting resin material and a second thermosetting resin material are heated, and the first thermosetting resin material and the second thermosetting resin material are covered with a thermoplastic resin in a state where the first thermosetting resin material is cured and the second thermosetting resin material is in semi-cured. Thereby, a chemical bond is generated between the semi-cured second thermosetting resin and the thermoplastic resin to improve contactness between the sealing member made of the second thermosetting resin material and the sealing member made of the thermoplastic resin.

However, in the proposed technique, peeling may occur between the first thermosetting resin material and the second thermosetting resin material. It is considered that the reason for this is that gas generated when the first thermosetting resin material is cured is enclosed between the first thermosetting resin material and the semi-cured second thermosetting resin.

Specifically, it is considered that when the first thermosetting resin material such as an acid anhydride curing type epoxy resin typically used for casting for example is cured, the first thermosetting resin material generates gas such as a vaporized curing agent or desorbed carbon dioxide. Such gas cannot pass through the semi-cured second thermosetting resin, so that the gas may be enclosed at the interface between the first sealing member made of the first thermosetting resin material and the second sealing member made of the second thermosetting resin material. As a result, the contactness between the first sealing member and the second sealing member is deteriorated, which may cause peeling to occur between the first sealing member and the second sealing member.

The proposed technique requires the first thermosetting resin and the second thermosetting resin to be cured at different temperatures. For this reason, it is necessary to perform heating at, for example, two-or-more-staged temperatures, which causes complicated temperature control during heating and curing. This causes deteriorated productivity, which disadvantageously causes increased production costs.

The present disclosure provides a resin-sealed component which can prevent peeling between a first sealing member and a second sealing member to provide excellent contactness between the first sealing member and the second sealing member. The present disclosure further provides a method for manufacturing the same.

In an first aspect of the present disclosure, a resin-sealed component comprises: a part to be sealed; a first sealing member covering at least a part of the part to be sealed; and a second sealing member sealing a surface of the first sealing member. The first sealing member and the second sealing member are made of thermosetting resins. The second sealing member is made of the thermosetting resin having a gelation time longer than that of the first sealing member.

In an second aspect of the present disclosure, a method for producing a resin-sealed component including: a part to be sealed; a first sealing member covering at least a part of the part to be sealed and made of a cured product of a first thermosetting resin composition; and a second sealing member covering a surface of the first sealing member and made of a cured product of a second thermosetting resin composition comprises: introducing the first thermosetting resin composition to cover, with the first thermosetting resin composition, at least a part of the part to be sealed; introducing the second thermosetting resin composition having a gelation time longer than that of the first thermosetting resin composition to cover the first thermosetting resin composition with the second thermosetting resin composition; and heating the first thermosetting resin composition and the second thermosetting resin composition to obtain the resin-sealed component.

According to the above aspect, the resin-sealed component has a structure in which the first sealing member made of the thermosetting resin is covered with the second sealing member made of the thermosetting resin having the gelation time longer than that of the first sealing member. Therefore, when the resin-sealed component is produced, even if the thermosetting resins constituting the first sealing member and the second sealing member are heated at the same timing, the thermosetting resin of the second sealing member is in an uncured state when the thermosetting resin of the first sealing member is cured. Therefore, even if gas is generated when the thermosetting resin of the first sealing member is cured, the gas passes through the uncured thermosetting resin of the second sealing member and is released to the outside. This makes it possible to prevent peeling from occurring between the first sealing member and the second sealing member, whereby the resin-sealed component has excellent contactness between the first sealing member and the second sealing member.

As described above, the resin-sealed component is produced by, for example, introducing the first thermosetting resin composition, introducing the second thermosetting resin composition, and heating the first thermosetting resin composition and the second thermosetting resin composition. The first thermosetting resin composition is introduced for the resin-sealed component. Thereby, at least a part of the part to be sealed is covered with the first thermosetting resin composition. Further, when the second thermosetting resin composition is introduced, the second thermosetting resin composition having a gelation time longer than that of the first thermosetting resin composition is introduced to the first thermosetting resin composition. Thereby, the first thermosetting resin composition is covered with the second thermosetting resin composition.

The first thermosetting resin composition and the second thermosetting resin composition are heated. By heating the first thermosetting resin composition and the second thermosetting resin composition, the first thermosetting resin composition having a relatively shorter gelation time than that of the second thermosetting resin composition is first cured. Even if gas or the like is generated when the first thermosetting resin composition is cured, the gas passes through the second thermosetting resin composition which has a relatively longer gelation time than that of the first thermosetting resin composition and which is uncured when the first thermosetting resin composition is cured. This makes it possible to prevent the gas from being enclosed between the first sealing member and the second sealing member and prevent the peeling from occurring. Therefore, it is possible to produce the resin-sealed component having excellent contactness between the first sealing member and the second sealing member.

According to the above aspect, it is possible to heat the first thermosetting resin composition and the second thermosetting resin composition at the same timing. For example, it is possible to heat the first thermosetting resin composition and the second thermosetting resin composition at a predetermined temperature equal to or higher than the curing temperatures of the first thermosetting resin composition and the second thermosetting resin composition. This eliminates the need for performing heating at, for example, two-staged temperatures, which provides easy temperature control during heating and curing. Even if the first thermosetting resin composition and the second thermosetting resin composition are heated at the same timing and at the same temperature, the second thermosetting resin composition is in an uncured state as described above when the first thermosetting resin composition is cured, whereby it is possible to prevent the peeling of the interface. By maintaining a predetermined temperature equal to or higher than the above-described curing temperature, it is possible to cure the second thermosetting resin composition after the first thermosetting resin composition is cured.

As described above, the above aspects can provide the resin-sealed component preventing the peeling between the first sealing member and the second sealing member and providing excellent contactness between the first sealing member and the second sealing member, and can provide the method for producing the same.

### Embodiment

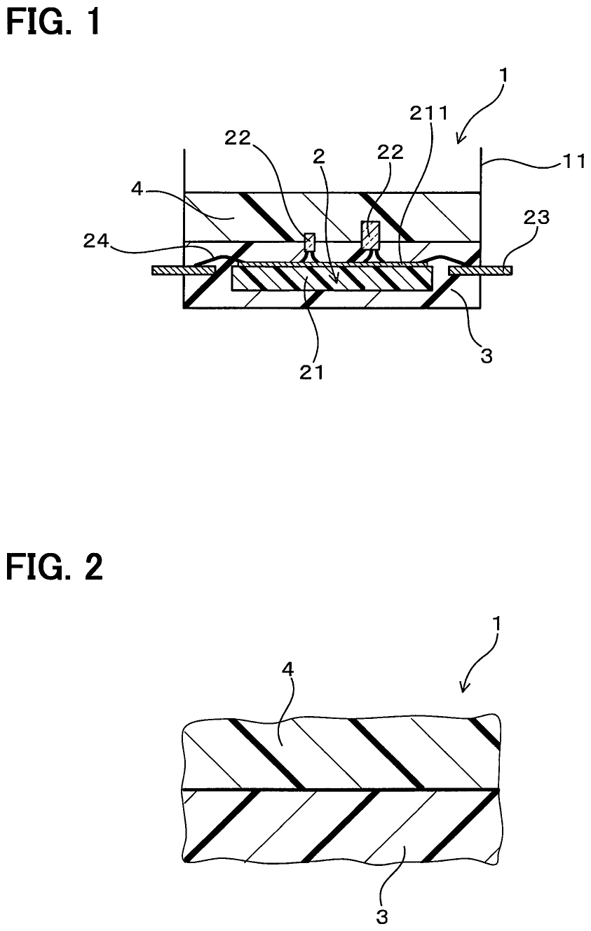

An embodiment of a resin-sealed component and a method for producing the same will be described with reference to FIGS. 1 to 3. As shown in FIG. 1, a resin-sealed component 1 includes a part to be sealed 2, a first sealing member 3, and a second sealing member 4.

The part to be sealed 2 is not particularly limited but may include a substrate 21 on which an electronic circuit 211 is formed, for example. Various electronic components 22 may be mounted on the part to be sealed 2. The electronic components 22 are connected to the electronic circuit 211 by, for example, a solder. Examples of the electronic components 22 include a columnar electrolytic capacitor extending upright from the substrate 21.

The part to be sealed 2 is disposed in, for example, a casing 11. Specifically, the resin-sealed component 1 may include the casing 11.

Both the first sealing member 3 and the second sealing member 4 are made of thermosetting resins. Hereinafter, the thermosetting resin constituting the first sealing member 3 is referred to as a first thermosetting resin, and the thermosetting resin constituting the second sealing member 4 is referred to as a second thermosetting resin.

As the first thermosetting resin and the second thermosetting resin, resins having different gelation times are used. The gelation time is measured in accordance with a gelation time A method described in 5.14.1 of JIS K 6910 (2007). The measurement is performed on a composition before curing. Specifically, 1 cc of a composition obtained by uniformly mixing a base compound with a curing agent at a prescribed ratio is applied onto a hot plate previously held at a temperature of 140 degrees Celsius, and slowly stirred by using a glass rod so that a small circle is drawn. A point at which the composition suddenly becomes a rubbery mass is regarded as an end point of gelation. The gelation time is determined by components of the composition.

The gelation time of the thermosetting resin after curing may be determined. In this case, first, by gas chromatograph mass spectrometry (that is, GC-MS analysis), Fourier transform infrared spectroscopic analysis (that is, FT-IR analysis), nuclear magnetic resonance analysis (that is, NMR analysis), or the like, components of the first thermosetting resin and components of the second thermosetting resins are analyzed. Then, based on the analysis results, the composition before curing may be adjusted and the gelation time described above may be measured. That is, the gelation time of the thermosetting resin after curing can be further specified.

The second sealing member 4 is made of a thermosetting resin having a gelation time longer than that of the first sealing member 3. That is, the gelation time T1_{gel} of the first thermosetting resin and the gelation time T2_{gel} of the second thermosetting resin satisfy the relationship T2_{gel}−T1_{gel}>0.

When the second sealing member 4 contains two or more thermosetting resins, the gelation time is calculated from an arithmetic mean value based on the mass ratio of the gelation times of the thermosetting resins. The same applies to the first sealing member 3.

Preferably, the second sealing member 4 is made of a thermosetting resin having a gelation time longer than that of the first sealing member 3 by 20 minutes or more. That is, T 2_{gel}−T1_{gel}≥20 minutes is preferable. In this case, in the production of the resin-sealed component 1, the first sealing member 3 can be sufficiently cured when the second sealing member 4 is in an uncured state. This sufficiently prevents peeling between the first sealing member 3 and the second sealing member 4, whereby contactness between the first sealing member 3 and the second sealing member 4 can be further improved. From the viewpoint of further improving the contactness and obtaining, for example, a more reliable component which is suitable for the resin-sealed component 1 for automotive use such as an engine control unit, T2_{gel}−T1_{gel}≥60 minutes is more preferable, and T2_{gel}−T1_{gel}≥80 minutes is still more preferable.

For example, an epoxy resin, a bismaleimide-based resin, a phenol-based resin, or a blended resin thereof may be used as the first thermosetting resin constituting the first sealing member 3. Further, an urethane resin may be used as the first thermosetting resin as long as the relationship of T2_{gel}−T1_{gel}>0 is satisfied. For example, from the viewpoint of improving electrical reliability through reducing a difference in thermal expansion coefficient between the first sealing member 3 and the part to be sealed 2 having a soldered portion, it is preferable that the first sealing member 3 be made of an epoxy resin having excellent hardness, excellent heat resistance, excellent adhesiveness, and the like.

The epoxy resin is not particularly limited to specific one. A bisphenol type epoxy resin, an aromatic multifunctional epoxy resin, a phenol-based polyfunctional epoxy resin, a naphthalene type epoxy resin, an epoxy resin having an alicyclic skeleton in which a benzene ring of the aforementioned epoxy resin is hydrogenated, an aliphatic epoxy resin, or the like is used as the epoxy resin. The epoxy resin used may be one type or two or more types among the foregoing.

Examples of the bisphenol type epoxy resin include a bisphenol A type epoxy resin and a bisphenol F type epoxy resin. Examples of the aromatic multifunctional epoxy resin include a glycidyl amine type epoxy resin.

Examples of the phenol-based polyfunctional epoxy resin include a phenol novolak type epoxy resin and a cresol novolak type epoxy resin.

Examples of the naphthalene type epoxy resin include a bifunctional type epoxy resin such as EPICLON HP-4032D manufactured by DIC Corporation. Examples of the naphthalene type epoxy resin include a tetrafunctional type epoxy resin such as EPICLON HP-4700 manufactured by DIC Corporation.

Examples of the aliphatic epoxy resin include epoxy compounds having an aliphatic skeleton such as trimethylolpropane, ethylene glycol, and trimethylolpropane.

Preferably, the epoxy resin is an acid anhydride-cured epoxy resin. The acid anhydride-cured epoxy resin is an epoxy resin in which an acid anhydride serves as a curing agent, and which tends to easily generate gas such as carbon dioxide and an unreacted acid anhydride during curing. Therefore, the thermosetting resins satisfying the above-described predetermined relationship of T2_{gel}−T1_{gel}>0 are used as the first sealing member 3 and the second sealing member 4, whereby a more remarkable peeling prevention effect is provided.

That is, in general, the use of the acid anhydride-cured epoxy resin as the first thermosetting resin is apt to cause peeling between the first sealing member 3 and the second sealing member 4, which tends to cause decreased contactness. However, the use of the resin having a longer gelation time than that of the first thermosetting resin 3 as the second thermosetting resin 4 provides a more remarkable effect of further preventing the peeling between the first sealing member 3 and the second sealing member 4 to improve the contactness.

Preferably, the second sealing member contains a thermosetting resin having a gelation time of 60 minutes or more. This case provides an increase in option of selecting the first thermosetting resin to satisfy the relationship of T 2_{gel}−T1_{gel}>0. Therefore, it is possible to use the first thermosetting resin that is more suitable for the required characteristics of a product.

For example, an urethane resin, a silicone resin, a modified silicone resin, a polyester resin, a polyacrylic resin, a flexible epoxy resin, or the like is used as the second thermosetting resin constituting the second sealing member 4. An urethane resin is preferable. In this case, the material cost of the second sealing member 4 is reduced, whereby the production cost of the resin-sealed component can be reduced, and further, the second sealing member 4 can sufficiently prevent the wetting of the part to be sealed 2. By selecting, for example, an isocyanate for the urethane resin, the gelation time is easily adjusted.

The urethane resin is obtained by causing a polyol to react with an isocyanate compound. It is preferable to use an aliphatic isocyanate as the isocyanate compound. That is, it is preferable that the urethane resin have a structural unit derived from a polyol and a structural unit derived from an aliphatic isocyanate. In this case, it is possible to lengthen the gelation time of the second thermosetting resin. This makes it possible to make the gelation time of the second thermosetting resin sufficiently longer than that of the first thermosetting resin. As a result, the peeling between the first sealing member and the second sealing member is further prevented, whereby the contactness can be further improved. In the aliphatic isocyanate, an isocyanate group (i.e., —NCO) is bonded to not an aromatic ring but an aliphatic hydrocarbon. It is considered that the urethane resin having a structural unit derived from an aliphatic isocyanate has a steric hindrance at a curing reaction site during curing, so that the curing reaction is delayed to cause the gelation time to be prolonged as described above.

The polyol is not particularly limited to specific one. For example, a castor oil-based polyol, a polycarbonate-based polyol, a polyester-based polyol, a polyacrylic polyol, a polyether-based polyol, or the like may be used. Polyolefin-based polyol such as a polybutadiene-based polyol and a polyisoprene-based polyol may be used as the polyol. A hydrogenated product having a double bond in a skeleton may be used as the polyolefin-based polyol. The polyol used may be one type or two or more types among the foregoing. From the viewpoint of a further improvement in contactness between the first sealing member 3 and the second sealing member 4, a castor oil-based polyol and a polycarbonate-based polyol are preferred. Because the polycarbonate-based polyol has a large number of polar carbonate groups, the polycarbonate-based polyol has high affinity with the first thermosetting resin containing a polar group-containing epoxy resin or the like. Therefore, it is more preferable that the polyol component of the urethane resin be a polycarbonate-based polyol.

Examples of the aliphatic isocyanate include tetramethylxylylene diisocyanate (i.e., TMXDI), hexamethylene diisocyanate (i.e., HDI), isophorone diisocyanate (i.e., IPDI), xylylene diisocyanate (i.e., XDI), and a hydrogenated product thereof (i.e., H6-XDI). As the aliphatic isocyanate, one or two or more of them can be used.

Preferably, the aliphatic isocyanate has an aromatic ring. In this case, when the first sealing member 3 is made of, for example, an epoxy resin such as a bisphenol type epoxy resin, the contactness between the first sealing member 3 and the second sealing member 4 can be further improved. This is because an urethane resin having an aromatic ring and an epoxy resin having an aromatic ring have high affinity due to stacking interaction between the aromatic rings.

Examples of the aliphatic isocyanate having an aromatic ring include tetramethylxylylene diisocyanate (i.e., TMXDI) and xylylene diisocyanate (i.e., XDI).

Preferably, the aliphatic isocyanate contains at least TMXDI. In this case, the gelation time of the second thermosetting resin becomes sufficiently long, and the contactness between the second thermosetting resin and the first thermosetting resin such as an epoxy resin is further improved. This makes it possible to further improve the contactness between the first sealing member 3 and the second sealing member 4.

A structural formula of TMXDI is shown in the following formula (1). As shown in the formula (1), TMXDI has a structure in which two isocyanate groups are respectively bonded to two aliphatic hydrocarbons, and each of the aliphatic hydrocarbons is bonded to a common aromatic ring. That is, TMXDI is one type of an aliphatic isocyanate having an aromatic ring.

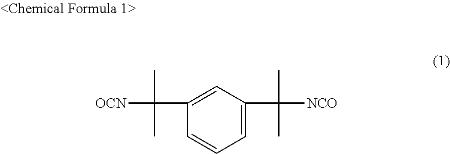

A structure of urethane in which TMXDI and a polyol react with each other is shown in the formula (2). As shown in the formula (2), an urethane bond is formed by TMXDI and a polyol. Preferably, the urethane resin has a structural unit derived from TMXDI and a structural unit derived from a polyol as shown in the formula (2).

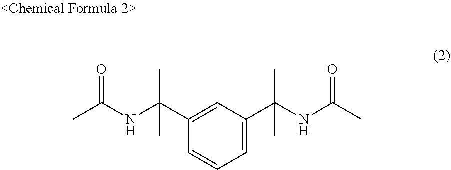

A peeling ratio R_{d} between the first sealing member 3 and the second sealing member 4 is preferably 15% or less. In this case, the resin-sealed component 1 can exhibit sufficiently excellent contactness, for example, for automobile use. The peeling ratio R_{d} is more preferably 10% or less, still more preferably 5% or less, and most preferably 0.

The peeling ratio R_{d} is calculated from an area S of an interface between the first sealing member 3 and the second sealing member 4 and an area S₁ of a peeled region based on the formula R_{d}=100×S₁/S. The area S₁ of the peeled region may be measured by observing the interface between the first sealing member 3 and the second sealing member 4 from a second sealing member side.

The part to be sealed 2 includes, for example, the substrate 21 on which the electronic circuit 211 is formed, and the electronic components 22 mounted on the substrate 21. Preferably, the first sealing member 3 covers at least the electronic circuit 211. In this case, the electronic circuit 211 is protected by the first sealing member 3 made of, for example, an epoxy resin, having high hardness and excellent heat resistance. The first sealing member 3 can further protect, for example, a solder joint portion in the electronic circuit 211. Therefore, the electrical reliability of the resin-sealed component 1 is improved.

Preferably, the second sealing member 4 covers at least a part of at least the electronic components 22. In this case, for example, the second sealing member 4 made of an urethane resin exhibits appropriate flexibility. Therefore, even if an overcurrent is generated, an explosion-proof valve in the head portion of the electronic components 22 including an electrolytic capacitor or the like absorbs the overcurrent, whereby an internal stress can be released.

The resin-sealed component 1 is used, for example, as an electronic control unit. Specifically, the resin-sealed component 1 is used for controlling various sensors, for example. The resin-sealed component 1 may be used for an engine control unit (that is, an ECU) for automotive use. In this case, even if the resin-sealed component 1 is exposed to moisture, the resin-sealed component 1 is protected by the sealing resin, whereby stable performance of the ECU can be kept.

In the resin-sealed component 1 of the present embodiment, as illustrated in FIG. 1, the first sealing member 3 made of the thermosetting resin is covered with the second sealing member 4 made of the thermosetting resin having a gelation time longer than that of the first sealing member 3. Therefore, even if the thermosetting resins constituting the first sealing member 3 and the second sealing member 4 are heated at the same timing when the resin-sealed component 1 of the present embodiment is produced, the thermosetting resin of the second sealing member 4 is in an uncured state when the thermosetting resin of the first sealing member 3 is cured. Therefore, even if gas is generated when the thermosetting resin of the first sealing member 3 is cured, the gas passes through the uncured thermosetting resin in the second sealing member 4, and is released to the outside. Therefore, as illustrated in FIG. 2, the resin-sealed component 1 can prevent the peeling from occurring between the first sealing member 3 and the second sealing member 4, whereby the resin-sealed component 1 has excellent contactness between first sealing member 3 and the second sealing member 4.

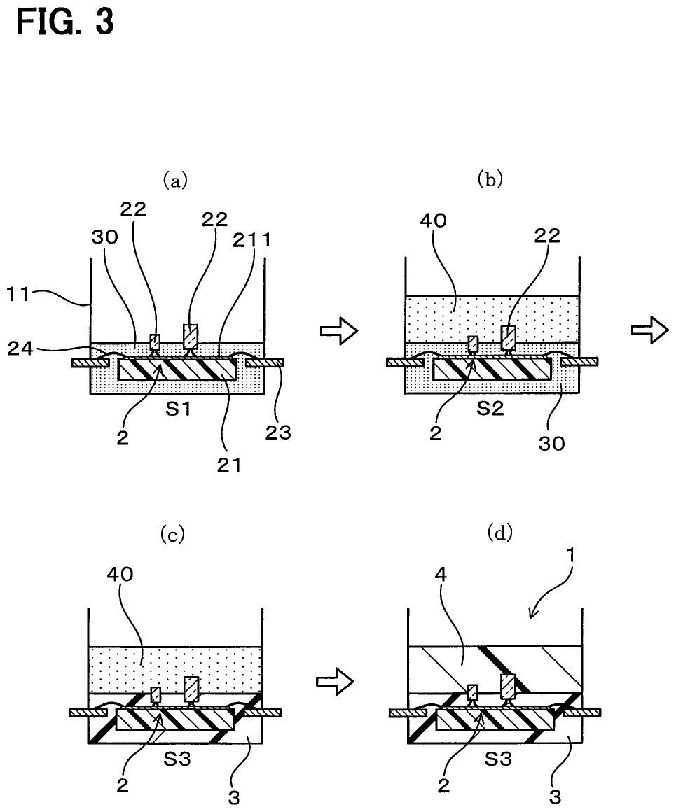

Next, a method for producing a resin-sealed component will be described with reference to FIGS. 3A to 3D. As illustrated in FIGS. 3A to 3D, the resin-sealed component 1 is produced by performing a first introducing step S₁, a second introducing step S2, and a heating step S3. Hereinafter, the method will be described in detail.

In the first introducing step S₁, as illustrated in FIG. 3 (a), for example, a part to be sealed 2 placed in a casing 11 or the like is prepared. The part to be sealed 2 includes, for example, a substrate 21 on which an electronic circuit 211 is formed, electronic components 22, and an external connection terminal 23. The external connection terminal 23 is connected to the electronic circuit 211 by, for example, a wire 24. A part of the external connection terminal 23 is exposed to an outside of the casing 11.

Next, a first thermosetting resin composition 30 is introduced into the casing 11. Thereby, as illustrated in FIG. 3 (a), at least a part of the part to be sealed 2 is covered with the first thermosetting resin composition 30. In the first introducing step S₁, it is preferable that at least the electronic circuit 211 be covered with the first thermosetting resin composition 30. In this case, at least the electronic circuit 211 can be covered with the first sealing member 3 made of the first thermosetting resin after the heating step. Therefore, as described above, it is possible to produce the resin-sealed component 1 having excellent electrical reliability. In the first introducing step S₁, it is preferable that at least a part of the electronic components 22 be exposed, so that the electronic components 22 can be covered with a second thermosetting resin composition 40 in the later-described second introducing step S2.

Preferably, the first thermosetting resin composition 30 is made of an epoxy resin-based casting material. In this case, the first sealing member 3 made of an epoxy resin can be formed. The effect in this case is as described above.

For example, the epoxy resin-based casting material contains: a base compound containing an epoxy compound; and a curing agent. In the epoxy resin-based casting material, it is preferable to use an acid anhydride-based curing agent because of low viscosity and castability improvement. In this case, the first sealing member 3 made of an acid anhydride epoxy resin can be formed. See the above-description for an advantage in this case.

As illustrated in FIG. 3 (b), in the second introducing step S2, the second thermosetting resin composition 40 is introduced. Thereby, the first thermosetting resin composition 30 is covered with the second thermosetting resin composition 40. The part to be sealed 2 can be completely covered with the first thermosetting resin composition 30, or with the first thermosetting resin composition 30 and the second thermosetting resin composition 40. When a part of the electronic components 22 are exposed in the first introducing step S₁, the exposed part of the electronic components 22 can be covered with the second thermosetting resin composition 40 in the second introducing step.

Preferably, the second thermosetting resin composition 40 is made of an urethane resin-based casting material. In this case, the second sealing member 4 made of an urethane resin can be formed. See the above-description for an advantage in this case.

In the heating step S3, the first thermosetting resin composition 30 and the second thermosetting resin composition 40 are heated. Specifically, for example, an inside of the casing 11, into which the first thermosetting resin composition 30 and the second thermosetting resin composition 40 were sequentially introduced, is heated. Thereby, as illustrated in FIGS. 3 (c) and (d), the first thermosetting resin composition 30 and the second thermosetting resin composition 40 are cured, whereby the first sealing member 3 made of the first thermosetting resin and the second sealing member 4 made of the second thermosetting resin can be formed. Thus, the resin-sealed component 1 is obtained.

In the second introducing step, the second thermosetting resin composition 40 having a gelation time longer than that of the first thermosetting resin composition 30 is used. Therefore, in the heating step S3, the first thermosetting resin composition 30 having a relatively shorter gelation time than that of the second thermosetting resin composition 40 is first cured.

Therefore, as illustrated in FIG. 3 (c), even if gas or the like is generated when the first thermosetting resin composition 30 is cured, the gas can sufficiently pass through the uncured second thermosetting resin composition 40 during curing of the first thermosetting resin composition 30. This is because the gelation time is relatively longer than that of the first thermosetting resin composition 30, whereby the first thermosetting resin composition 30 can be sufficiently cured before the second thermosetting resin composition 40 is cured.

This makes it possible to prevent the gas from being enclosed between the first sealing member 3 and the second sealing member 4 and prevent peeling from occurring. As a result, it is possible to produce the resin-sealed component 1 having excellent contactness between the first sealing member 3 and the second sealing member 4. From the viewpoint of more sufficiently preventing the peeling and further improving the contactness, the gelation time T1_{gel} of the first thermosetting resin composition 30 and the gelation time T2_{gel} of the second thermosetting resin composition 40 preferably satisfy T2_{gel}−T1_{gel} 20 minutes, more preferably T2_{gel}−T1_{gel} 60 minutes, and still more preferably T2_{gel} 80 minutes.

In the heating step S3, the first thermosetting resin composition 30 and the second thermosetting resin composition 40 can be heated at the same timing. The heating can be performed, for example, at temperatures equal to higher than the curing temperatures of the second thermosetting resin composition 30 and the second thermosetting resin composition 40. The heating temperature may be, for example, a predetermined temperature. That is, in the heating step S3, there is no need to perform heating at multistage temperatures such as two or more-staged temperatures, for example, and temperature control during heating and curing becomes easy.

Even if the first thermosetting resin composition 30 and the second thermosetting resin composition 40 are heated at the same timing and at the same temperature, the second thermosetting resin composition 40 is in an uncured state as described above when the first thermosetting resin composition 30 is cured, whereby the peeling of the interface can be prevented. In the heating step S3, by maintaining a predetermined temperature equal to or higher than the above-described curing temperature without changing the heating temperature, the second thermosetting resin composition 40 can be cured after the first thermosetting resin composition 30 is cured.

As described above, the present embodiment can provide the resin-sealed component in which the peeling between the first sealing member and the second sealing member is prevented to provide excellent contactness between the first sealing member and the second sealing member, and can provide the method for producing the same.

In the following mode and experimental example, the same reference numerals as those used in the above-described embodiment are used to refer to like constituent elements unless otherwise indicated.

(Comparative Mode)

In the present mode a resin-sealed component having a second sealing member made of a thermosetting resin having a gelation time shorter than that of a first sealing member will be described. Like the embodiment, in the resin-sealed component of the present mode, the first sealing member is made of an epoxy resin and the second sealing member is made of an urethane resin, but the first sealing member has a longer gelation time than the second sealing member.

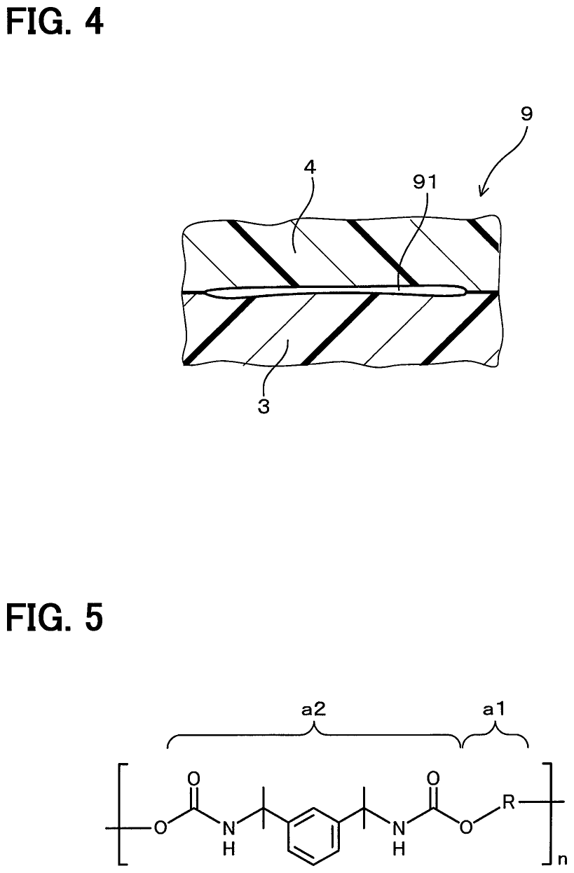

Therefore, as illustrated in FIG. 4, in a resin-sealed member 9 of the present mode, a large peeled region 91 is observed at an interface between a first sealing member 3 and a second sealing member 4. It is considered that there is a gas phase in the peeled region 91. Meanwhile, in the resin-sealed component 1 of the embodiment, as illustrated in FIG. 2, little or no peeled region is observed.

### Experimental Example

In the present example, a plurality of resin-sealed components according to the embodiment and the comparative examples are prepared, and a peeled state of an interface between a first sealing member and a second sealing member in each of the resin-sealed components and the contactness of the interface are evaluated. As shown in Table 1, the resin-sealed components of the embodiment and the comparative examples were prepared by using first and second thermosetting resin compositions containing different components.

As the first thermosetting resin composition, an epoxy-based casting material was used. As the second thermosetting resin composition, an urethane-based casting material was used. In each of the compositions, a base compound and a curing agent are mixed in an equivalent ratio.

First, the epoxy-based casting material was introduced into a casing in which a part to be sealed was placed. Subsequently, the urethane-based casting material was introduced so as to be superposed on the previously introduced epoxy-based casting material. Thereafter, the casing into which each of the casting materials was poured was placed in a thermostatic chamber, and heated at 140 degrees Celsius for 4 hours. Thereby, each of the thermosetting resin compositions was cured to obtain a resin-sealed component having a multi-layer sealing structure. The resin-sealed component of the present example is an electronic control unit.

The epoxy-based and urethane-based casting materials used in the present example are as follows.

Epoxy-based casting material A: Two-liquid mixed type casting material containing a bisphenol A type epoxy resin and an acid anhydride.

Epoxy-based casting material B: One-liquid type casting material containing a bisphenol A type epoxy resin and a latent catalyst.

Urethane-based casting material A: Two-liquid mixed type casting material consisting of a castor oil-based polyol and MDI.

Urethane-based casting material B: Two-liquid mixed type casting material consisting of a castor oil-based polyol and HDI.

Urethane-based casting material C: Two-liquid mixed type casting material consisting of a castor oil-based polyol and XDI.

Urethane-based casting material D: Two-liquid mixed type casting material consisting of a castor oil-based polyol and TMXDI.

Urethane-based casting material E: Two-liquid mixed type casting material consisting of a polycarbonate-based polyol and TMXDI.

MDI is diphenylmethane diisocyanate; HDI is hexamethylene diisocyanate; XDI is xylylene diisocyanate; and TMXDI is tetramethylxylylene diisocyanate.

In Example 1, the epoxy-based casting material A was used as the first thermosetting resin composition. The urethane-based casting material C was used as the second thermosetting resin composition. The amounts used are shown in Table 1.

In Example 2, the epoxy-based casting material A was used as the first thermosetting resin composition. The urethane-based casting material D was used as the second thermosetting resin composition. The amounts used are shown in Table 1.

In Example 3, the epoxy-based casting material A was used as the first thermosetting resin composition. The urethane-based casting material E was used as the second thermosetting resin composition. The amounts used are shown in Table 1.

In Example 4, the epoxy-based casting material B was used as the first thermosetting resin composition. The urethane-based casting material D was used as the second thermosetting resin composition. The amounts used are shown in Table 1.

In Example 5, the epoxy-based casting material A was used as the first thermosetting resin composition. As the second thermosetting resin composition, a mixture of the urethane-based casting material A and the urethane-based casting material D was used. The amounts used are shown in Table 1.

In Example 6, the epoxy-based casting material A was used as the first thermosetting resin composition. The urethane-based casting material B was used as the second thermosetting resin composition. The amounts used are shown in Table 1.

In Comparative Example 1, the epoxy-based casting material A was used as the first thermosetting resin composition. The urethane-based casting material A was used as the second thermosetting resin composition. The amounts used are shown in Table 1.

In Comparative Example 2, the epoxy-based casting material A was used as the first thermosetting resin composition. As the second thermosetting resin composition, a mixture of the urethane-based casting material A and the urethane-based casting material D was used. The amounts used are shown in Table 1.

Evaluation was performed as follows.

<Interface State>

For each of the resin-sealed components of Examples and Comparative Examples, the interface between the first sealing member made of a cured product of the first thermosetting resin composition and the second sealing member made of a cured product of the second thermosetting resin composition was observed. Subsequently, a ratio of an area S₁ of a peeled region to an area S of the entire interface was calculated, and this value was taken as a peeling ratio R_{d}. A case where the peeling ratio R_{d} was less than 5% was evaluated as “Excellent”; a case where the peeling ratio R_{d} was 5% or more and less than 20% was evaluated as “Good”; and a case where the peeling ratio R_{d} was 20% or more was evaluated as “Unacceptable”. The results are shown in Table 1.

<Interfacial Adhesiveness>

The second sealing member was attempted to be peeled off by hand from the first sealing member. A case where the second sealing member was broken without being peeled off at the interface was evaluated as “Excellent”; a case where the second sealing member and the first sealing member were peeled off from each other at the interface, but the second sealing member and the first sealing member were securely adhered to each other was evaluated as “Good”;

a case where the second sealing member and the first sealing member were peeled off from each other at the interface, but the second sealing member and the first sealing member were adhered to each other at a certain degree of adhesive force was evaluated as “Acceptable”; and a case where the first sealing member was easily peeled off from the second sealing member at the interface was evaluated as “Unacceptable”. It was confirmed that there was a distinct difference between the judgment criteria of “Good” and “Acceptable”.

TABLE 1

| | | Examples, Comparative Examples No. | | | | | | | | | | | | | | |
|---|---|---|---|---|---|---|---|---|---|---|---|---|---|---|---|---|
| | | | | | | | | | | | | | Comparative | | Comparative | |
| | | Example 1 | | Example 2 | | Example 3 | | Example 4 | Example 5 | | Example 6 | | Example 1 | | Example 2 | |
| First | Epoxy-based casting | 10 | g | 10 | g | 10 | g | — | 10 | g | 10 | g | 10 | g | 10 | g |
| sealing | material A | | | | | | | | | | | | | | | |
| member | (T1_{gel}: 40 minutes) | | | | | | | | | | | | | | | |

| | | | | | | | | | |
|---|---|---|---|---|---|---|---|---|---|
| Epoxy-based casting | — | — | — | 10 | g | — | — | — | — |
| material B | | | | | | | | | |
| (T1_{gel}: 20 minutes) | | | | | | | | | |

| | | | | | | | | | | | | |
|---|---|---|---|---|---|---|---|---|---|---|---|---|
| Second | Urethane-based | — | — | — | — | 5 | g | — | 20 | g | 10 | g |
| sealing | casting material A | | | | | | | | | | | |
| member | (T2_{gel}: 10 minutes) | | | | | | | | | | | |

| | | | | | | | | | |
|---|---|---|---|---|---|---|---|---|---|
| Urethane-based | — | — | — | — | — | 20 | g | — | — |
| casting material B | | | | | | | | | |
| (T2_{gel}: 60 minutes) | | | | | | | | | |

| | | | | | | | | | |
|---|---|---|---|---|---|---|---|---|---|
| Urethane-based | 20 | g | — | — | — | — | — | — | — |
| casting material C | | | | | | | | | |
| (T2_{gel}: 60 minutes) | | | | | | | | | |

| | | | | | | | | | | | | |
|---|---|---|---|---|---|---|---|---|---|---|---|---|
| Urethane-based | — | 20 | g | — | 20 | g | 15 | g | — | — | 10 | g |
| casting material D | | | | | | | | | | | | |
| (T2_{gel}: 120 minutes) | | | | | | | | | | | | |

| | | | | | | | | | |
|---|---|---|---|---|---|---|---|---|---|
| Urethane-based | — | — | 20 | g | — | — | — | — | — |
| casting material E | | | | | | | | | |
| (T2_{gel}: 120 minutes) | | | | | | | | | |

| | | | | | | | | | | | | | | | | |
|---|---|---|---|---|---|---|---|---|---|---|---|---|---|---|---|---|
| T2_{gel} − T1_{gel} | 20 | minutes | 80 | minutes | 80 | minutes | 100 | minutes | 60 | minutes | 20 | minutes | −30 | minutes | 15 | minutes |

| | | | | | | | | | |
|---|---|---|---|---|---|---|---|---|---|
| Interface state | Peeling | 15% | <5% | <5% | 0 | 10% | 15% | 70% | 50% |
| (appearance) | ratio | | | | | | | | |
| | Judgment | Good | Excellent | Excellent | Excellent | Good | Good | Un- | Un- |
| | | | | | | | | acceptable | acceptable |
| Interfacial | Judgment | Good | Good | Excellent | Good | Good | Acceptable | Good | Good |
| adhesiveness | | | | | | | | | |

As is known from Table 1, in Examples 1 to 6 which satisfy the relationship of T2_{gel}−T1_{gel}>0, the peeling ratio of the first sealing member and the second sealing member was low, which provided excellent interfacial contactness. Meanwhile, in Comparative Examples 1 and 2 which did not satisfy the above relationship, the peeling ratio was high, which caused insufficient interfacial contactness.

As shown in FIG. 5, in Examples 2 to 5, an urethane resin having a structural unit a1 derived from a polyol and a structural unit a2 derived from TMXDI were used as the second sealing member. That is, TMXDI is used as an isocyanate component of the urethane resin. In this case, it can be seen that the peeling ratio can be further reduced. Example 3 using a polycarbonate-based polyol as the polyol provided further improvement in contactness.

The present disclosure is not limited to the above-described embodiment and Experimental Example and the like, and can be applied to various embodiments without departing from the spirit and the scope of the present disclosure. For example, the surface of the second sealing member may be covered with a third sealing member made of a thermoplastic resin and the like. As the thermoplastic resin, for example, a polyphenylene sulfide resin, a polybutylene terephthalate resin, a polyolefin resin, polyethylene, polystyrene, an ABS resin, PMMA, polyester, polyurethane, and the like may be used.

What is claimed is:

1. A resin-sealed component comprising:
a part to be sealed;
a first sealing member covering at least a part of the part to be sealed; and
a second sealing member sealing a surface of the first sealing member,
wherein:
the first sealing member and the second sealing member are made of thermosetting resins; and
the second sealing member is made of the thermosetting resin having a gelation time longer than that of the first sealing member by 20 minutes or more.

2. The resin-sealed component according to claim 1, wherein
the first sealing member is made of an epoxy resin.

3. The resin-sealed component according to claim 2, wherein
the epoxy resin is an acid anhydride-cured epoxy resin.

4. The resin-sealed component according to claim 1, wherein
the second sealing member contains the thermosetting resin having the gelation time of 60 minutes or more.

5. The resin-sealed component according to claim 1, wherein
the second sealing member is made of an urethane resin.

6. The resin-sealed component according to claim 5, wherein
the urethane resin has a structural unit derived from a polyol and a structural unit derived from an aliphatic isocyanate.

7. The resin-sealed component according to claim 6, wherein
the aliphatic isocyanate has an aromatic ring.

8. The resin-sealed component according to claim 6, wherein
the aliphatic isocyanate contains tetramethylxylylene diisocyanate.

9. The resin-sealed component according to claim 1, wherein
a peeling ratio of an interface between the first sealing member and the second sealing member is 15% or less.

10. The resin-sealed component according to claim 1, wherein:
the part to be sealed includes a substrate on which an electronic circuit is formed, and an electronic component mounted on the substrate;
the first sealing member covers at least the electronic circuit; and
the second sealing member covers at least a part of at least the electronic component.

11. The resin-sealed component according to claim 1, wherein
the resin-sealed component is an electronic control unit.

12. A method for producing a resin-sealed component,
the resin-sealed component including:
a part to be sealed;
a first sealing member covering at least a part of the part to be sealed and made of a cured product of a first thermosetting resin composition;
and
a second sealing member covering a surface of the first sealing member and made of a cured product of a second thermosetting resin composition,
the method comprising:
introducing the first thermosetting resin composition to cover, with the first thermosetting resin composition, at least a part of the part to be sealed;
introducing the second thermosetting resin composition having a gelation time longer than that of the first thermosetting resin composition by 20 minutes or more to cover the first thermosetting resin composition with the second thermosetting resin composition; and
heating the first thermosetting resin composition and the second thermosetting resin composition to obtain the resin-sealed component.

13. The method according to claim 12, wherein
the first thermosetting resin composition is made of an epoxy resin-based casting material.

14. The method according to claim 13, wherein
the epoxy resin-based casting material contains an acid anhydride-based curing agent.

15. The method according to claim 12, wherein
the gelation time of the second thermosetting resin composition is 60 minutes or more.

16. The method according to claim 12, wherein
the second thermosetting resin composition is made of an urethane resin-based casting material.

17. The method according to claim 16, wherein
the urethane resin-based casting material contains a polyol and an aliphatic isocyanate.

18. The method according to claim 17, wherein
the aliphatic isocyanate has an aromatic ring.

19. The method according to claim 17, wherein
the aliphatic isocyanate contains tetramethylxylylene diisocyanate.

20. The method according to claim 12, wherein:
the part to be sealed includes a substrate on which an electronic circuit is formed and an electronic component mounted on the substrate;
when the first thermosetting resin composition is introduced, at least the electronic circuit is covered with the first thermosetting resin composition; and
when the second thermosetting resin composition is introduced, at least a part of the electronic component is covered with the second thermosetting resin composition.

21. The method according to claim 12, wherein
the resin-sealed component is an electronic control unit.
